(19) United States
(12) Patent Application Publication
(10) Pub. No.: US 2014/0149093 A1
(43) Pub. Date: May 29, 2014

(54) MODELING CONTENT DATA FOR GENERATING INFORMATION MODELS

(71) Applicant: James Michael AMULU, Bangalore (IN)

(72) Inventor: James Michael AMULU, Bangalore (IN)

(21) Appl. No.: 13/686,936

(22) Filed: Nov. 28, 2012

(51) Int. Cl. G06F 17/50

(52) U.S. Cl. CPC G06F 17/50
USPC 703/6

(57) ABSTRACT

In one embodiment, a selection of a type of an information view is received. Further, an import option to select an existing information model is rendered on a computer generated user interface for modeling content data for the selected information view. In response to receiving the selection of the import option, content data of the existing information model is rendered by presenting table objects corresponding to the content data on a content data editor interface, wherein the table objects comprises identification of connections and cardinality between table columns of the table objects. The content data is modeled for the selected information view using at least one of the rendered selected content data and the source of table objects. Furthermore, an information model for the selected information view is generated by activating the modeled content data.

### FIELD

Embodiments generally relate to information modeling and more specifically to methods and systems to model content data for generating an information model by importing content data of existing information models.

### BACKGROUND

Organizations include large volumes of information (e.g., transactional information and master data) associated with their business operations. Further, analyzing such information facilitates in understanding the state of the business operations and help in decision making. For example, information models are used to create multiple views of the information used for analytical purposes. Thereby, development tools are developed to build such information model. The development tools are graphical data modeling tools which allow designing analytical information models and analytical privileges that govern the access to those models. Further, the information model designing process involves building content data (e.g., also referred as data foundation) for generating information models. The content data is a schema that defines the relevant tables and relationships from one or more relational databases. However, current users of information design tools have to manually re-create the entire content data of same tables by understanding the existing relational databases every time for generating different information models, which is a tedious and time consuming process.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating information modeling process flow, according to one embodiment.

FIG. 2 shows exemplary graphical user interface illustrating an information modeler interface, according to one embodiment.

FIG. 3 is a flow diagram illustrating a method of modeling content data for generating information models, according to an embodiment.

FIG. 4 shows exemplary graphical user interface illustrating process block 320 of FIG. 3, according to an embodiment.

FIG. 5 shows exemplary graphical user interface illustrating a content data editor interface, according to an embodiment.

FIG. 6 is a block diagram illustrating a computing environment in which the techniques described for modeling content data for generating information models can be implemented, according to an embodiment.

### DETAILED DESCRIPTION

Embodiments of techniques to generate information models by importing content data from existing information models are described herein. According to various embodiments, development tools are used to build information models. One such example is SAP HANA studio from SAP® AG. SAP HANA is an in-memory database allowing high-performance processing and analysis of data on the database and prevents the necessity to transfer data from the database to an application server. Further, the in-memory database allows modeling data as tables and views. Tables are tabular data structures, each row identifying a particular entity, and each column having a unique name. Further, views are combinations and selections of data from tables modeled to serve a particular business purpose.

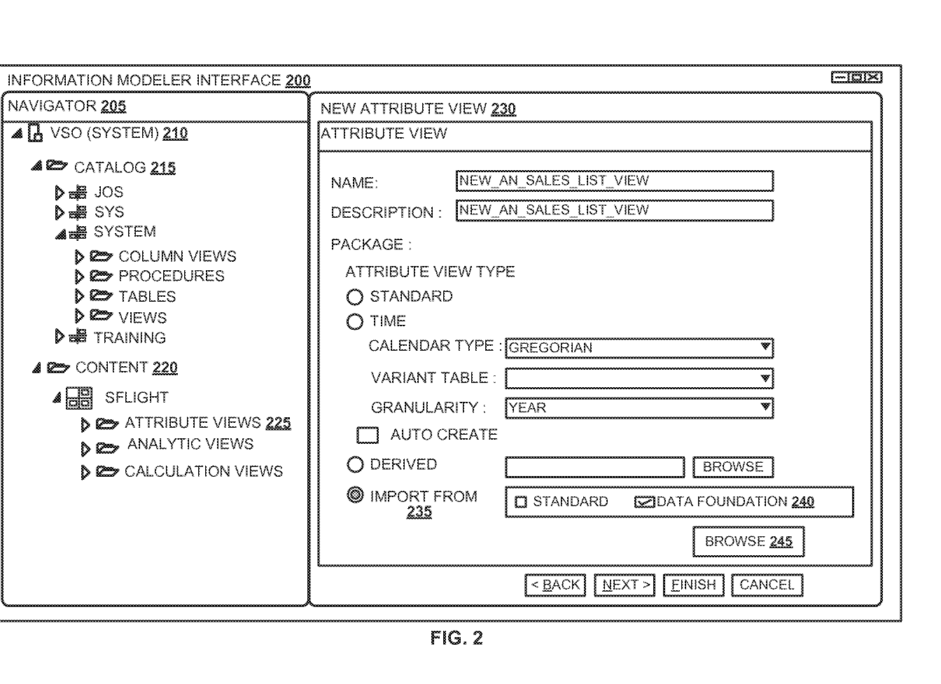

Further, the SAP HANA studio is a development tool of SAP HANA. The SAP HANA studio also referred to as SAP HANA modeler is a graphical data modeling tool which allows designing analytical models and analytical privileges that govern the access to those models. The information model designing process in the SAP HANA modeler involves building content data for generating information models. The content data is a schema that defines the relevant tables and relationships from one or more relational databases. Further, the SAP HANA studio information modeler allows creating new or modifying existing information models. These models are called ‘information models’ and they are also interchangeably referred to as ‘column views’, ‘HANA views’, ‘HANA models’ or ‘HANA cubes’. In one exemplary embodiment, different types of information views of the information models can be generated. For example, the information view can be an attribute view, an analytic view and a calculation view, which are described in greater detail in FIG. 2.

According to one embodiment, in response to receiving a selection to generate a type of an information view, an import option to retrieve required content data (e.g., also referred as data foundation) associated with an existing information model for modeling content data for the selected information view are rendered. Further, using the required content data associated with the existing information model and source of table objects, content data of the selected information view is modeled. In one embodiment, the content data of the existing information models includes identification of connections and cardinality between table columns of the table objects associated with the content data. Since the content data with the connection and the cardinality are presented, re-creating the same content data is avoided and thus save the time invested in re-creating the created content data. Therefore, the content data of the existing information model can be reused to address multiple business scenarios using the same information model with or without reduction or enhancement of the content data of the existing information model.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

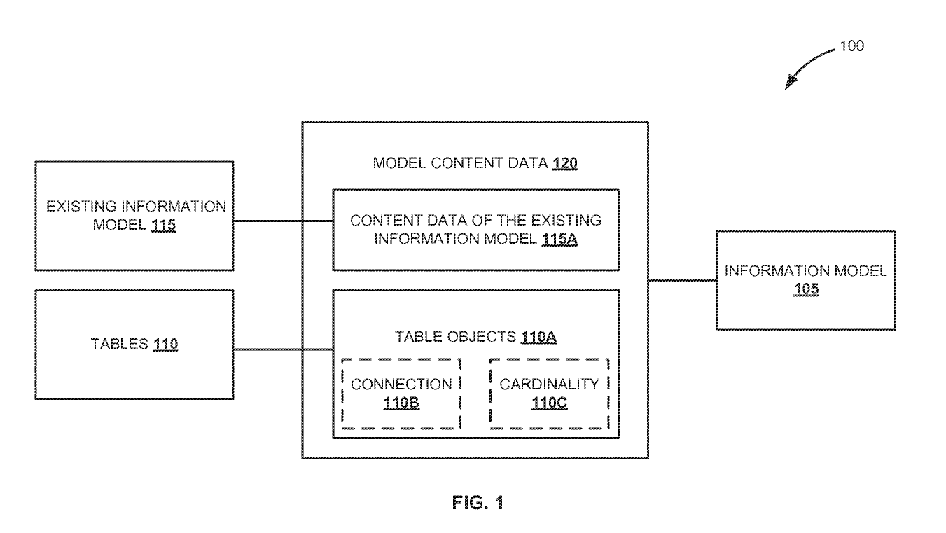

FIG. 1 is a block diagram 100 illustrating information modeling process flow, according to one embodiment. An information model 105 is generated by modeling content data (e.g., 120, also referred as data foundation) relevant to the information model 105. In one embodiment, the content data is modeled using at least one of an existing information model 115 and tables 110. In one embodiment, when the existing information model 115 is selected for modeling the content data (e.g., 120), content data of the existing information model 115A is retrieved. Further, connection and cardinality associated with table objects corresponding to the content data of the existing information model 115A are automatically populated from a file source, where the content data of the existing information model 115A is stored. Therefore, the process of providing connection and cardinality by understanding the table objects of the content data of an existing information model 115 is avoided.

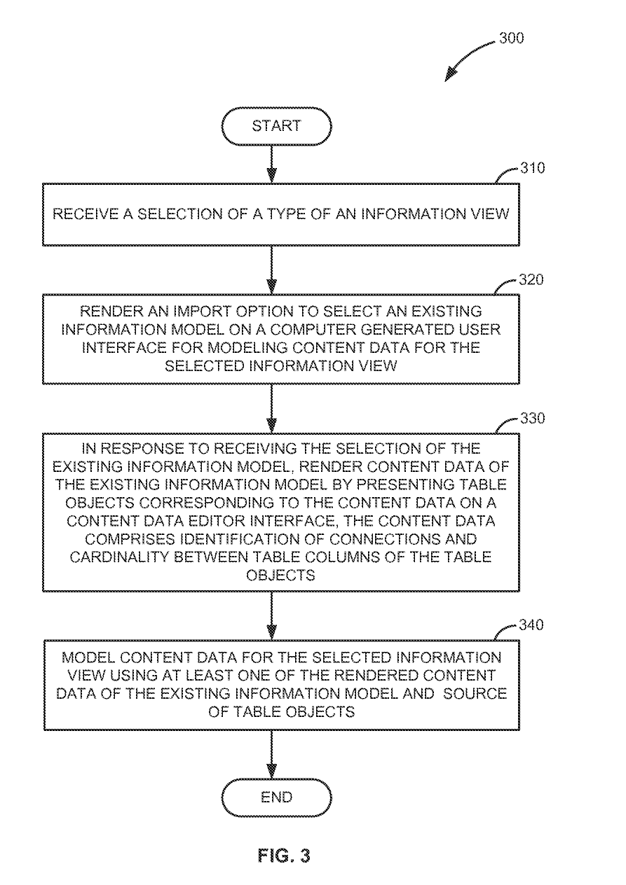

In one embodiment, an option is provided to alter the content data of the existing information model 115A for generating the information model 105 by adding table objects 110A of tables 110 to the content data of the existing information model 115A. In that scenario, a user or a designer of the information model 105 has to manually determine connection 110B and cardinality 110C between the table objects 110A. In one exemplary embodiment, the table objects 110A are formed by importing table definitions (e.g., source system metadata into a modeler perspective) and the tables 110 are loaded with content data. The process of generating the information model is described in greater detail with an example in FIG. 3.

In one exemplary embodiment, development tools are used to generate the information models using the method illustrated in FIG. 3. An exemplary graphical user interface illustrating an information modeler interface 200 for generating the information models is shown in FIG. 2. The information modeler interface 200 offers features to generate and edit information models.

In one embodiment, the information model generation process involves defining a space in a repository of the system wherein to store the generated information models. The defined space is created as a node, also referred to as a package on the information modeler interface 200. For example, in the information modeler interface 200, a newly added system node 210 ‘VS0 (system)’ is added to the ‘navigator’ 205 pane. The expanded system node 210 ‘VS0 (system)’ shows two sub-nodes ‘catalog’ 215 and ‘content’ 220. The ‘catalog’ 215 sub-node represents in-memory data dictionary, i.e., all data structures, tables, and data which can be used to model content data for generating information models. The sub-node ‘content’ 220 represents the design-time repository which holds all models crated within the information modeler.

In one exemplary embodiment, different types of information views of the information models can be generated, such as an attribute view, an analytic view and a calculation view. The information views may use various combinations of the content data to model a business use case (e.g., the information model). For example, the attribute view is used to model an entity based on the relationships between attribute data contained in multiple source tables (e.g., table objects). Attribute view describes the dimensions of the information model. For example, customer ID is the attribute data that describes measures (e.g., who purchased a product). However, customer ID has much more depth to it when joined with other attribute data that further describes the customer (customer address, customer relationship, customer status, customer hierarchy, and so on). Further, the attribute view can be created to locate the attribute data and to define the relationships between the various tables to model how customer attribute data, for example, will be used to address business needs. Attribute views can later be joined to tables that contain measures within the definition of the analytic view or the calculation view to create virtual star schema on the data.

The analytic view is used to model data that includes measures. The analytic view describes the facts related to some dimensions. For example, an operational data mart representing sales order history may include measures for quantity, price, and the like. The content data of the analytic view can contain multiple tables. However, measures that are selected for inclusion in the analytic view must originate from one of these tables. In general, the analytic views can be simply a combination of tables that contain both attribute data and measure data.

The calculation view is used to define more advanced slices on the data. Calculation view renders complex models that can combine multiple analytic views or that can be defined programmatically using the SQL script language. The calculation views are typically used when the business use case requires advanced logic that is not covered in the previous types of information views. For example, calculation views can have layers of calculation logic, can include measures sourced from multiple source tables, can include advanced SQL logic and so on. The content data of the calculation view can include any combination of tables, the attribute views and the analytic views.

FIG. 3 is a flow diagram 300 illustrating a method of modeling content data for generating information models, according to an embodiment. The method 300, implemented by a computer or any other electronic device having processing capabilities, includes at least the following process illustrated with reference to process blocks 310 to 340. At process block 310, a selection of a type of an information view is received. In the example shown in FIG. 2, the selection of the attribute view 225 is received. Further, in response to receiving the selection of the type of information view, a user interface (e.g., a dialogue window ‘new attribute view’ 230) is rendered on the modeler main window to receive input specifying details such as a name and description for the selected information view.

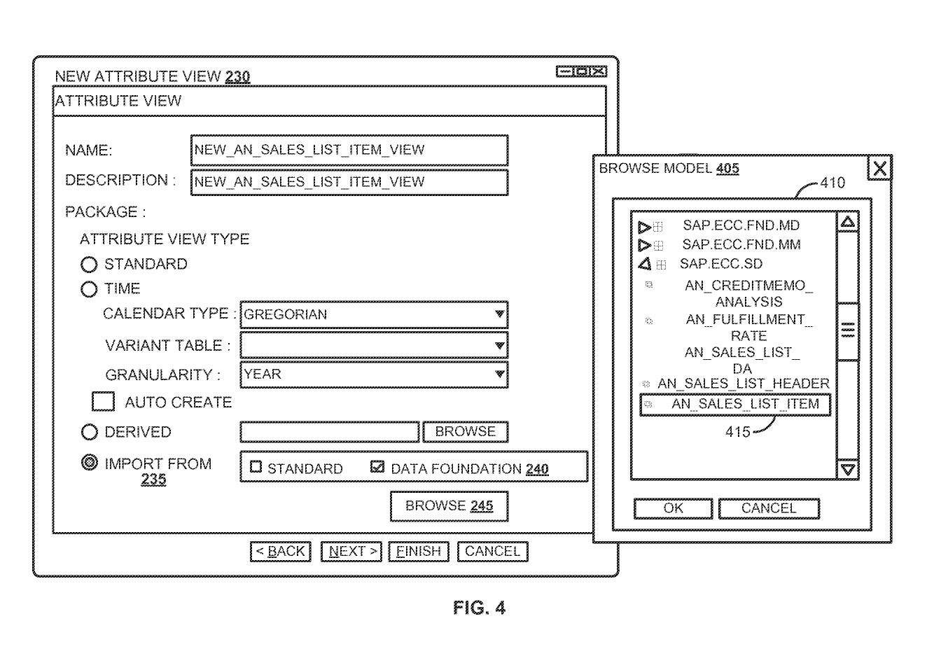

At process block 320, an import option to select an existing information model is rendered for modeling content data for the selected information view. In the example, the ‘import from’ 235 is provided to select required ‘data foundation’ 240 (i.e., content data) from the existing information model using a ‘browse’ 245 option. Upon determining that the ‘import from’ 235 option is selected from the dialogue window, a file explorer is launched for identifying and invoking the existing information models. For example, a ‘browse model’ 405 displaying details of the existing information models (e.g., 410) is rendered as shown in FIG. 4.

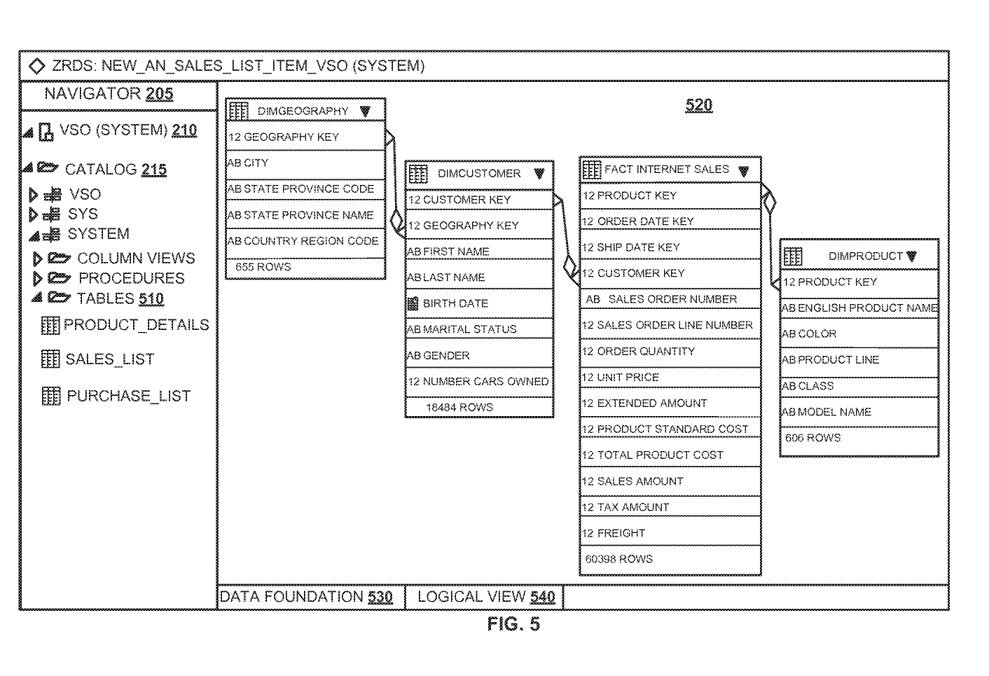

At process block 330, in response to receiving the selection of the existing information model through import option, content data of the selected existing information model is rendered by presenting table objects corresponding to the selected content data on a content data editor interface. The presented table objects include identification of connections and cardinality between table columns of the table objects. In one embodiment, the connections and the cardinality are automatically identified from the file source of the existing information model. For example, upon receiving the selection of the existing information model AN_SALES_LIST_ITEM 415 of the ‘browse model’ 405, the content data editor interface 520 of FIG. 5 is displayed, where the information modeler tool automatically extracts the corresponding table objects (e.g., dimensions, measures, hierarchies, attributes, pre-defined calculations, functions, and queries) along with the content data defining the tables and joins. In the content data editor interface 520, the content data of the existing information model AN_SALES_LIST_ITEM 415 is displayed as shown in 520 under ‘data foundation’ 530 tab.

At process block 340, the content data is modeled for the selected information view using at least one of the rendered content data of the existing information model and source of table objects. In one embodiment, an option is provided to modify the rendered table objects of the content data of the existing information model. Modifying the rendered table objects includes at least one of adding one or more table objects from the source of table objects to the rendered table objects and deleting one or more table objects associated with the existing information model. For example, the table objects as presented under ‘tables’ 510 of ‘catalog’ 215 node can be added to the rendered content data of the existing information model AN_SALES_LIST_ITEM in the content data editor interface 520. When the table objects under ‘tables’ 510 (e.g., ‘product_details’, ‘sales_list’ and ‘purchase_list’) is added to the content data editor interface 520, the connection and cardinality between the table objects has to be defined to complete the content data modeling.

In one embodiment, the information model is generated for the selected information view by activating the modeled content data. For example, the modeled content data as shown in the content data editor 520 can be activated for generating the information model using a logical view 540 tab as shown in FIG. 5. Further, the modeled content data of the generated information model is stored in a file source. Thereby, NEW_AN_SALES_LIST_ITEM information model is generated corresponding to the selected attribute view and stored in the file source. Similarly, analytic views and calculation views can be generated. Therefore, when modeling attribute view, identification of attributes, the connection and the cardinality between the table objects can be avoided. When modeling analytical view, identification of attributes, measures, the connection and cardinality between the table objects can be avoided. Similarly, when modeling calculation views, segregation of the attributes, the measures, the connection and cardinality between the table objects can be avoided as the content data is retrieved from the existing information models.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of or in combination with machine readable software instructions.

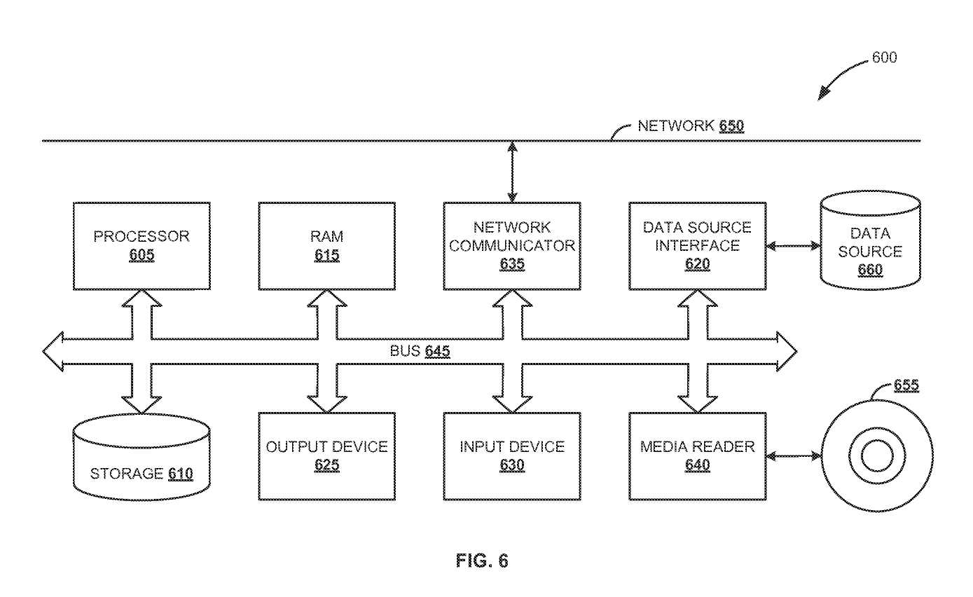

FIG. 6 is a block diagram of an exemplary computer system 600, according to an embodiment. The computer system 600 includes a processor 605 that executes software instructions or code stored on a computer readable storage medium 655 to perform the above-illustrated methods. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. An article of manufacture including a non-transitory computer readable storage medium to store instructions, which when executed by a computer, cause the computer to:
receive a selection of a type of an information view;
render an import option to select an existing information model on a computer generated user interface for modeling content data for the selected information view;
in response to receiving the selection of the existing information model, render content data of the existing information model by presenting table objects corresponding to the content data of the existing information model on a content data editor interface, wherein the table objects comprises identification of connections and cardinality between table columns of the table objects; and
model the content data for the selected information view using at least one of the rendered content data and source of table objects.

2. The article of manufacture of claim 1, further comprising instructions which when executed by the computer, cause the computer to: generate an information model for the selected information view by activating the modeled content data.

3. The article of manufacture of claim 2, further comprising instructions which when executed by the computer, cause the computer to: generating a package to store a generated information model.

4. The article of manufacture of claim 1, wherein the connections and the cardinality are automatically identified from a file source associated with the existing information model.

5. The article of manufacture of claim 1, wherein rendering the content data of the existing information model further comprises providing an option to modify the rendered table objects of the content data of the existing information model.

6. The article of manufacture of claim 5, wherein modifying table objects comprises at least one of adding one or more table objects from the source of table objects and deleting one or more table objects associated with the existing information model.

7. The article of manufacture of claim 2, wherein generating the information model further comprises storing modeled content data associated with the generated information model in a file source.

8. A computer implemented method to model content data for generating an information model, the method comprising:
receiving a selection of a type of an information view;
rendering an import option to select an existing information model on a computer generated user interface for modeling content data for the selected information view;
in response to receiving the selection of the existing information model, rendering content data of the existing information model by presenting table objects corresponding to the content data of the existing information model on a content data editor interface, wherein the table objects comprises identification of connections and cardinality between table columns of the table objects; and
modeling the content data for the selected information view using at least one of the rendered content data and source of table objects.

9. The computer implemented method of claim 8, further comprising generating the information model for the selected information view by activating the modeled content data.

10. The computer implemented method of claim 9, further comprising generating a package to store a generated information model.

11. The computer implemented method of claim 8, wherein the connections and the cardinality are automatically identified from a file source associated with the existing information model.

12. The computer implemented method of claim 8, wherein rendering the content data of the existing information model further comprises providing an option to modify the rendered table objects of the content data of the existing information model.

13. The computer implemented method of claim 12, wherein modifying table objects comprises at least one of adding one or more table objects from the source of table objects and deleting one or more table objects associated with the existing information model.

14. The computer implemented method of claim 9, wherein generating the information model further comprises storing modeled content data associated with the generated information model in a file source.

15. A computer system to model content data for generating an information model, the computer system comprising:
at least one processor; and
one or more memory devices communicative with the at least one processor, wherein the one or more memory devices store instructions to:
receive a selection of a type of an information view;
render an import option to select an existing information model on a computer generated user interface for modeling the content data for the selected information view;
in response to receiving the selection of the existing information model, render content data of the existing information model by presenting table objects corresponding to the content data of the existing information model on a content data editor interface, wherein the table objects comprises identification of connections and cardinality between table columns of the table objects; and
model the content data for the selected information view using at least one of the rendered content data and source of table objects.

16. The computer system of claim 15, further comprising generating an information model for the selected information view by activating the modeled content data.

17. The computer system of claim 16, further comprising generating a package to store the generated information model.

18. The computer system of claim 15, wherein the connections and the cardinality are automatically identified from a file source associated with the existing information model.

19. The computer system of claim 15, wherein rendering the content data of the existing information model further comprises providing an option to modify the rendered table objects of the content data of the existing information model.

20. The computer system of claim 19, wherein modifying table objects comprises at least one of adding one or more table objects from the source of table objects and deleting one or more table objects associated with the existing information model.
